(19) United States
(12) Patent Application Publication
(10) Pub. No.: US 2025/0112690 A1
(43) Pub. Date: Apr. 3, 2025

(54) WIRELESS TELECOMMUNICATIONS APPARATUSES AND METHODS

(71) Applicant: Sony Group Corporation, Tokyo (JP)

(72) Inventors: Martin Warwick BEALE, Basingstoke (GB); Samuel Asangbeng ATUNGSIRI, Basingstoke (GB)

(73) Assignee: Sony Group Corporation, Tokyo (JP)

(21) Appl. No.: 18/865,693

(22) PCT Filed: Mar. 23, 2023
(86) PCT No.: PCT/EP2023/057463

§ 371 Date: Nov. 14, 2024

(30) Foreign Application Priority Data
May 23, 2022 (EP) 22174953.4

(51) Int. Cl. H04B 7/185; G01S 19/25

(52) U.S. Cl. CPC H04B 7/18554; G01S 19/258; H04B 7/18565

(57) ABSTRACT

A wireless telecommunications apparatus for use with a non-terrestrial wireless telecommunications network, the wireless telecommunications apparatus comprising circuitry configured to: receive first information associated with a satellite of the non-terrestrial wireless telecommunications network, the first information comprising incomplete ephemeris information of the satellite; transmit a signal usable by a second wireless telecommunications apparatus to verify a location of the wireless telecommunications apparatus relative to the satellite; and receive second information associated with the satellite, the second information being usable by the wireless telecommunications apparatus to determine complete ephemeris information of the satellite.

### BACKGROUND

### Field of Disclosure

The present disclosure relates to wireless telecommunications apparatuses and methods.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Future wireless communications networks will be expected routinely and efficiently to support communications with an ever-increasing range of devices associated with a wider range of data traffic profiles and types than existing systems are optimised to support. For example, it is expected future wireless communications networks will be expected efficiently to support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things” (IoT), and may typically be associated with the transmissions of relatively small amounts of data with relatively high latency tolerance. Other types of device, for example supporting high-definition video streaming, may be associated with transmissions of relatively large amounts of data with relatively low latency tolerance.

In view of an increasing demand for different device types, such as IoT, there is expected to be a desire for future wireless communications networks, for example those which may be referred to as 5G or new radio (NR) systems/new radio access technology (RAT) systems (as provided via the 3rd Generation Partnership Project, 3GPP, for example), as well as future iterations/releases of existing systems, to efficiently support connectivity over a wide range of environments and for a wide range of devices associated with different applications and different characteristic data traffic profiles and requirements. For example, in order to improve a coverage for communications devices (user equipment etc.) wireless communication networks may include infrastructure equipment mounted on or forming part of satellites which are able to provide coverage for wireless communications by transmitting and receiving radio signals to and from communications devices located on the earth. Such satellites may be geostationary or in low earth orbit or medium earth orbit as will be explained in more detail below. Communications networks which include infrastructure equipment mounted on or forming part of satellites are known as Non-Terrestrial Networks (NTNs). Such NTNs can be configured to include a complete range of services which would otherwise be provided by a terrestrial wireless communications network. However, some services such as location-based services can present new challenges.

### SUMMARY OF THE DISCLOSURE

The present technology is defined by the claims.

The following detailed description is exemplary, but not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of a new radio access technology (RAT) wireless communications system which may be configured to operate in accordance with certain embodiments of the present disclosure;

FIG. 2 is a schematic block diagram of an example infrastructure equipment and communications device which may be configured to operate in accordance with certain embodiments of the present disclosure;

FIG. 3 is an illustrative representation of a plurality of parts of infrastructure equipment forming a wireless communications network in which some parts of the infrastructure equipment are located in satellites above the Earth and other parts may be located on the ground of the Earth;

FIG. 4 is an illustrative representation of a plurality of parts of infrastructure equipment forming a wireless communications network that serves a user equipment, where some parts of the infrastructure equipment are located in satellites above the earth and operate in a transparent manner;

FIG. 5 is an illustrative representation of a plurality of parts of infrastructure equipment forming a wireless communication network that serves a user equipment, where some parts of the infrastructure equipment are located in satellites above the earth and perform some base station functionality;

FIG. 6 is an illustrative representation of a plurality of parts of infrastructure equipment forming a wireless communication network that serves a user equipment, where some parts of the infrastructure equipment are located in satellites above the earth;

FIG. 7 is an illustrative representation of triangulation performed on a user equipment in communication with three infrastructure equipment base stations;

FIG. 8 gives a representation of a number of resource elements in a wireless access interface that are reserved for the transmission of reference signals;

FIG. 9 is a representation of a positioning occasion transmission, showing the location and length of the positioning occasion transmission within the radio frames transmitted by an infrastructure equipment;

FIG. 10 is a simplified representation of the communication between an infrastructure equipment carried by a satellite and a user equipment;

FIG. 11 is a representation of downlink communications and communication timings between an infrastructure equipment carried by a satellite and a user equipment;

FIG. 12 is a representation of uplink communications and communication timings between an infrastructure equipment carried by a satellite and a user equipment;

FIG. 13 is a representation of location spoofing by a user equipment;

FIG. 14 represents first example signalling of the present technique;

FIG. 15 represents second example signalling of the present technique;

FIG. 16 represents a first method of the present technique; and

FIG. 17 represents a second method of the present technique.

### DETAILED DESCRIPTION OF THE EMBODIMENTS

### New Radio Access Technology (5G)

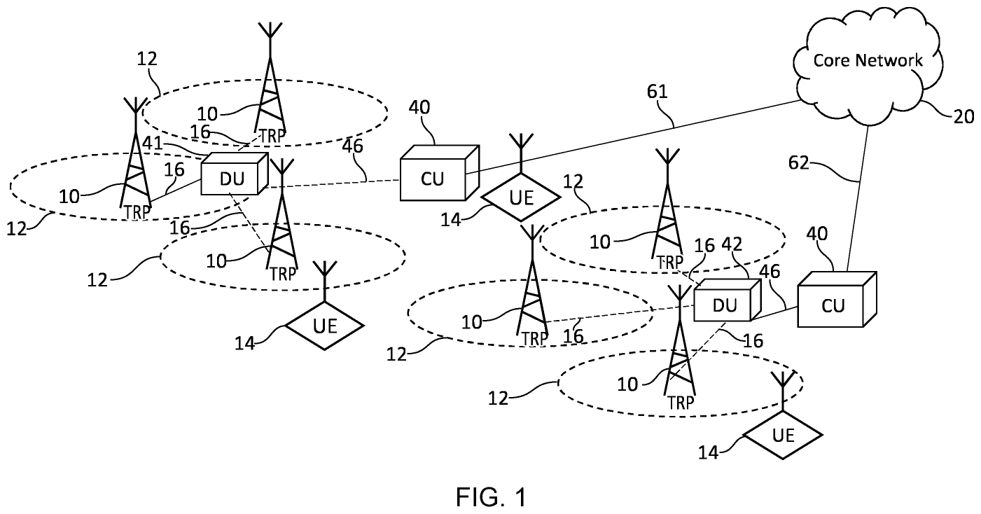

An example configuration of a wireless communications network which uses some of the terminology proposed for and used in NR and 5G is shown in FIG. 1. In FIG. 1 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10 forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks.

As will be appreciated by those acquainted with the wireless communications network according to a 5G standard as shown in FIG. 1, the CU 40, DU 42 and TRPs 10 (for example) collectively refer to functions which are conventionally performed by a network base station or, in accordance with 5G terminology, a gNB. The functional units of the CU 40, DU 42 and TRPs 10 may be geographically separated.

The TRPs 10 of FIG. 1 may in part have a corresponding functionality to a base station or eNodeB of an LTE network. Similarly, the communications devices 14 may be referred to as mobile terminals, terminals or user equipment (UE), which encompasses chip sets and have a functionality corresponding to the UE devices known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations, and communications devices of a new RAT network will be functionally similar to, respectively, the core network component, base stations, and communications devices of an LTE wireless communications network. Each of these devices (in particular, the communications devices 14 and TRPs 10 are examples of wireless telecommunications apparatuses).

In terms of broad top-level functionality, the term network infrastructure equipment/access node may be used to encompass these elements and more conventional base station type elements of wireless telecommunications systems. Depending on the application at hand, the responsibility for scheduling transmissions which are scheduled on the radio interface between the respective distributed units and the communications devices may lie with the controlling node/central unit and/or the distributed units/TRPs. A communications device 14 is represented in FIG. 1 within the coverage area of the first communication cell 12. This communications device 14 may thus exchange signalling with the first CU 40 in the first communication cell 12 via one of the distributed units/TRPs 10 associated with the first communication cell 12.

It will further be appreciated that FIG. 1 represents merely one example of a proposed architecture for a new RAT based telecommunications system in which approaches in accordance with the principles described herein may be adopted, and the functionality disclosed herein may also be applied in respect of wireless telecommunications systems having different architectures.

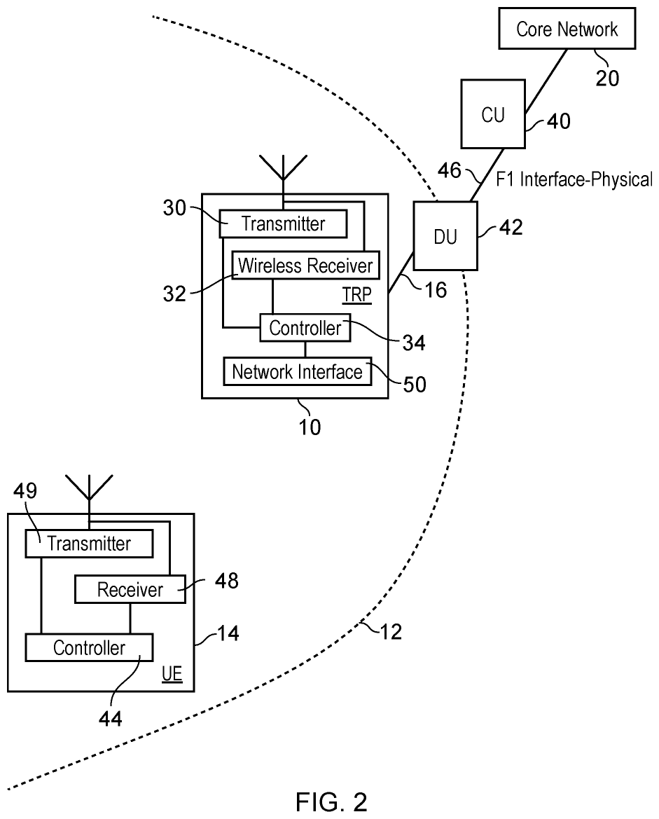

FIG. 2 provides a more detailed diagram of some of the components of the network shown in FIG. 1, with an indication of hardware components. In FIG. 2, a TRP 10 as shown in FIG. 1 comprises, as a simplified representation, a wireless transmitter 30, a wireless receiver 32 and a controller or controlling processor 34 which may operate to control the transmitter 30 and the wireless receiver 32 to transmit radio signals to and receive radio signals from one or more UEs 14 within a cell 12 formed by the TRP 10. As shown in FIG. 2, an example UE 14 is shown to include a corresponding wireless transmitter 49, wireless receiver 48 and controller or controlling processor 44 which is configured to control the transmitter 49 to transmit signals representing uplink data to the wireless communications network via the wireless access interface formed by the TRP 10 (the signals being received by the receiver 32, for example) and to control the receiver 48 to receive signals representing downlink data from the wireless communications network via the wireless access interface formed by the TRP (the signals being transmitted by the transmitter 30, for example).

The transmitters 30, 49 and the receivers 32, 48 (as well as other transmitters, receivers and transceivers described in relation to examples and embodiments of the present disclosure) are implemented using appropriate circuitry and may include radio frequency filters and amplifiers as well as signal processing components and devices in order to transmit and receive radio signals in accordance for example with the relevant 5G/NR standard(s). The controllers 34, 44 (as well as other controllers described in relation to examples and embodiments of the present disclosure) may be, for example, a microprocessor, a central processing unit (CPU), or a dedicated chipset, etc., configured to carry out instructions which are stored on a computer readable medium (optionally, a non-transitory computer readable medium), such as a non-volatile memory. The processing steps described herein may be carried out by, for example, a microprocessor in conjunction with a random access memory, operating according to instructions stored on a computer readable medium (optionally, a non-transitory computer readable medium). The transmitters, the receivers and the controllers are schematically shown in FIG. 2 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with their respective operating functionality.

As shown in FIG. 2, the TRP 10 also includes a network interface 50 which connects to the DU 42 via a physical interface 16 (this interface may be wired or wireless). The network interface 50 therefore provides a communication link for data and signalling traffic between the TRP 10 and the core network 20 via the DU 42 and the CU 40. The network interface 50 is implemented using appropriate circuitry, for example.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, for example, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

### Non-Terrestrial Networks (NTNs)

An NTN aerial vehicle (such as a satellite or aerial platform) may allow a connection of a communications device and a ground station (which may be referred to herein as an NTN gateway) [1]. In the present disclosure, the terms NTN aerial vehicle and NTN vehicle are used to refer to a space vehicle, aerial platform, satellite, or any other entity which moves relative to a communications device and is configured to communicate with a communications device. In particular, an NTN aerial vehicle may be in some embodiments a low earth orbit (LEO) satellite, a medium earth orbit (MEO) satellite, a high altitude platform system (HAPS), a balloon or a drone for example.

As a result of the wide service coverage capabilities and reduced vulnerability of space/airborne vehicles to physical attacks and natural disasters, Non-Terrestrial Networks are expected to:
foster the roll out of 5G service in un-served areas that cannot be covered by a terrestrial 5G network (e.g. isolated/remote areas, on board aircrafts or vessels) and underserved areas (e.g. sub-urban/rural areas) to upgrade the performance of limited terrestrial networks in a cost effective manner;
reinforce the 5G service reliability by providing service continuity for M2M (machine-to-machine)/IoT devices or for passengers on board moving platforms (e.g. passenger vehicles such as aircraft, ships, high speed trains, buses or the like) or ensuring service availability anywhere, especially for critical communications, future railway/maritime/aeronautical communications or the like; and
enable 5G network scalability by providing efficient multicast/broadcast resources for data delivery towards the network edges.

The benefits relate to either Non-Terrestrial Networks (NTNs) operating alone or to integrated terrestrial and Non-Terrestrial networks. They will impact at least coverage, user bandwidth, system capacity, service reliability or service availability, energy consumption and connection density. A role for NTN components in the 5G system is expected for at least the following verticals: Transport, Public Safety, Media and Entertainment, eHealth, Energy, Agriculture,

Finance and Automotive. It should also be noted that the same NTN benefits apply to 4G and/or LTE technologies and that while NR is sometimes referred to in the present disclosure, the teachings and techniques presented herein are equally applicable to 4G and/or LTE.

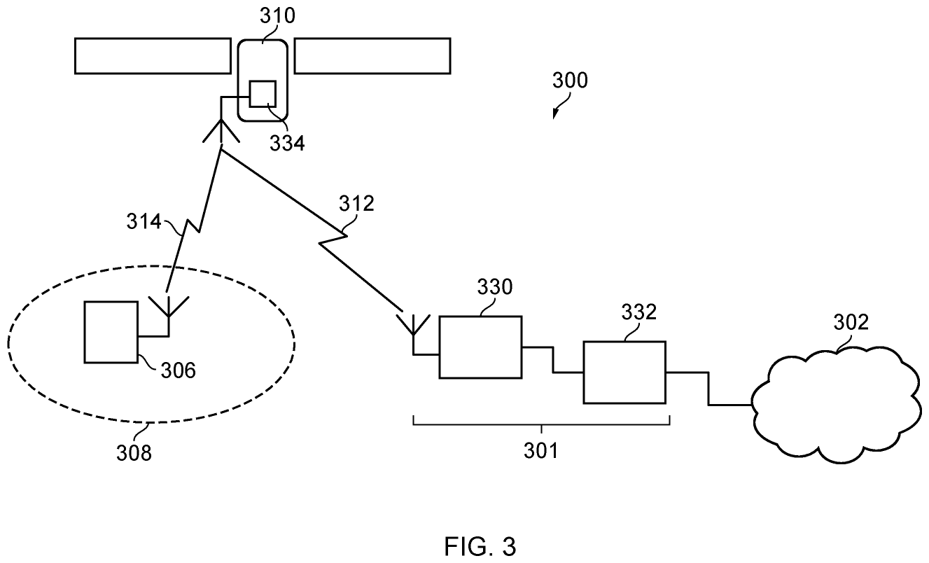

FIG. 3 schematically shows an example of a communications device 306 (with the same suitably configured components 44, 48, 49 of the communications device 14, for example) communicating with an NTN 300. The NTN 300 in FIG. 3 is based broadly around an LTE-type or NR-type architecture. Many aspects of the operation of the NTN 300 are known and understood and are not described here in detail in the interest of brevity. Operational aspects of the NTN which are not specifically described herein may be implemented in accordance with any known techniques, for example according to the current LTE-standard(s) or the proposed NR standard(s).

The NTN 300 comprises a core network part 302 (which may be a 4G core network or a 5G core network) in communicative connection with a radio network part 301. The radio network part 301 comprises a base station 332 connected to a ground station (or NTN gateway) 330, which may be formed as separate physical components and connected as in FIG. 3 or may be formed as a single physical component performing the functions of both the base station 332 and the ground station 330. The radio network part 301 may perform the functions of the TRP 10, DU 41, 42 and/or CU 40 of FIG. 1 (with the same suitably configured components 50, 30, 32, 34 of the TRP 10, for example) or may more broadly perform the functions of a base station such as an eNB or gNB in accordance with 4G or 5G standards.

The NTN 300 comprises an NTN aerial vehicle 310 which includes communications circuitry 334 for communicating with the communications device 306 and radio network part 301 via wireless communications links 314, 312.

The communications device 306 is located within a coverage area (or cell) 308 provided by the NTN 300. In the example shown in FIG. 3, the coverage area 308 is provided by a spot beam generated by the communications circuitry 334 of the NTN aerial vehicle 310. The boundary of the cell 308 may depend on an altitude of the NTN aerial vehicle 310 and a configuration of one or more antennas of the communications circuitry 334 by which the communications circuitry 334 transmits signals to and receives signals from the communications device 306.

The spot beam may be an “earth fixed beam” which covers a geographic area on a surface of the earth for a pre-defined period of time. Alternatively, the spot beam may be an “earth moving beam” which covers a constantly changing geographic area on the surface of the earth. In an example, the communications device 306 may determine, based on certain decision criteria, to switch from being served by an NTN aerial vehicle 310 that implements an “earth fixed beam” to an NTN aerial vehicle 310 that implements an “earth moving beam”, or may determine, based on similar criteria, to switch from being served by an NTN aerial vehicle 310 implementing an “earth fixed beam” to a “earth moving beam” provided by the same NTN aerial vehicle 310. The communications device 306 is able to determine these changes in both directions, that is, it is able to determine to switch from a fixed beam to a moving beam, and vice versa, and to switch between NTN aerial vehicles 310 that connect the communications device 306 to the NTN 300.

In FIG. 3, the ground station 330 is connected to the communications circuitry 334 by means of a wireless communications link 312. The communications circuitry 334 receives signals representing downlink data transmitted by the radio network part 301 on the wireless communications link 312 and transmits signals representing the downlink data via the wireless communications link 314 providing a wireless access interface for the communications device 306. Similarly, the communications circuitry 334 receives signals representing uplink data transmitted by the communications device 306 via the wireless communications link 314 and transmits signals representing the uplink data to the ground station 330 on the wireless communications link 312. The wireless communications links 312, 314 may operate at a same frequency, or may operate at different frequencies.

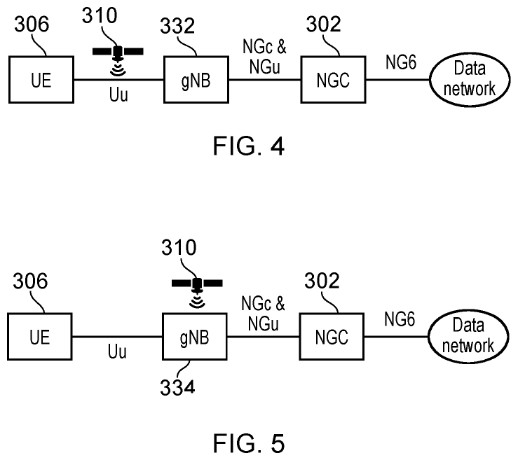

The extent to which the communications circuitry 334 processes the received signals depends on the processing capability of the communications circuitry 334 as explained in more detail with reference to FIGS. 4 and 5 below.

FIG. 4 illustrates an example of an NTN architecture based on the NTN aerial vehicle 310 operating in a transparent manner, meaning that a signal received from the communications device 306 at the NTN aerial vehicle 310 is forwarded (e.g. to a ground station 330 on Earth or to another NTN aerial vehicle) with only frequency conversion and/or amplification. In such implementations, a wireless access interface (such as an NR Uu interface) connecting the communications device 306 and the base station 332 located on the Earth is provided via the NTN aerial vehicle 310. In such implementations, the base station 332 may be regarded as “NTN infrastructure equipment”.

FIG. 5 illustrates an example of an NTN architecture where the communications circuitry 334 of the NTN aerial vehicle 310 implements at least some base station functionality. In such cases, the communications circuitry 334 is an example of “NTN infrastructure equipment”. The communications circuitry 334 generates the wireless access interface (such as an NR Uu interface) which connects the NTN aerial vehicle 310 and the communications device 306. For example, the communications circuitry 334 may decode a received signal, and encode and generate a transmitted signal. In other words, the communications circuitry 334 may include some or all of the functionality of a base station (such as a gNodeB or eNodeB). In some examples, latency-sensitive functionality (such as acknowledging a receipt of the uplink data, or responding to a RACH request) may be performed by the communications circuitry 334 partially implementing some of the functions of a base station. A wireless communications feeder link between the NTN aerial vehicle 310 and the ground station 330 may provide connectivity between the communications circuitry 334 and the core network part 302. In scenarios where the NTN aerial vehicle 310 implements at least some base station functionality, the base station 332 located on the Earth may not be present in the NTN 300.

As will be appreciated, the mobility of the coverage area 308 in NTNs can create technical challenges which may not occur in conventional terrestrial networks. For example, where the NTN aerial vehicle 310 is a LEO satellite, the NTN aerial vehicle 310 may complete an orbit of the Earth in around 90 minutes. In this case coverage area 308 generated by the NTN aerial vehicle 310 moves very rapidly with respect to a fixed observation point on the surface of the Earth (for example, a LEO may move at 7.56 km/s).

### Deployment of Network Elements as a Non-Terrestrial Network (NTN)

An example deployment of a 5G wireless communications network which may be used to improve coverage in some situations is a NR Non-Terrestrial Network (NTN), in which multiple satellites in orbit are used for LEO/MEO deployment with a transparent mode of operation. In transparent mode, the satellite functions as a “bent pipe” carrying RF signals, whilst the rest of the gNB functionality resides on the earth via terrestrial infrastructure equipment connected via a ground station or an NTN gateway (as exemplified in FIG. 4). However, there is an increased interest in regenerative satellites whereby the gNB or a part of a gNB functionality resides in the satellite (as exemplified in FIG. 5). The satellite may therefore carry a complete gNB functionality or each satellite may carry different gNB functionalities such as a CU, a DU or a TRP/Remote Radiohead (RRH).

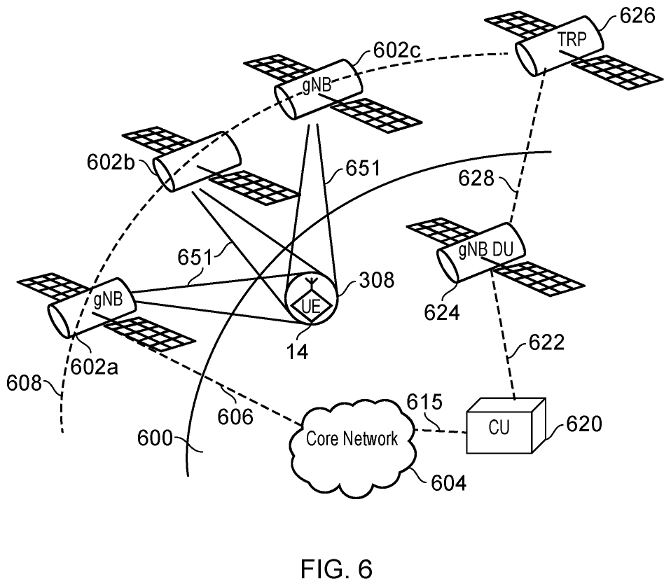

An example of this illustrated in FIG. 6, in which a plurality of satellites 602, 624, 626 are shown in orbit around the Earth 600 and in which each satellite includes certain functionality of a gNB. For example, a first satellite 602 includes the full functionality of a gNB (with the same suitably configured components 50, 30, 32, 34 of the TRP 10, for example) and connects to the core network 604 on the ground by an Earth to satellite link 606. Flightpath 608 signifies the flightpath of the first satellite 602, and representations 602a, 602b, and 602c are respective instances of the satellite at different points in time along the flightpath. A further example is shown in which the CU 620 is located on the Earth's surface 600 and connected via an Earth to satellite link 622 to a gNB DU carried by satellite 624. The satellite 624 carrying the gNB DU is connected to a satellite 626 carrying a TRP (with the same suitably configured components 50, 30, 32, 34 of the TRP 10, for example) via a communications link 628.

As will be appreciated from the following description, example embodiments can apply to both an NTN-based gNB formed from the combination of a TRP satellite 626, DU satellite 624 and earth-based CU 620 or an NTN vehicle carrying a complete gNB 602.

The gNB on board the NTN vehicle 602 may establish a beam 651 (e.g. via transmitter 30 and/or receiver 32) which covers and provides a wireless access interface for communications devices such as UE 14 in a cell 308 on the surface of the earth 600. It will be appreciated that, as the cell 308 is depicted in the same location on the surface of the earth 600 at successive instances of the flightpath of the satellite with gNB functionality 602, this example corresponds to an earth fixed beam example, as described above. This is not intended to limit the present disclosure to apply only to the earth fixed beams, but to include the earth moving beams also described above, with the necessary amendments made to the implementation of the enclosed details, as the skilled person would be able to apply them.

Need for verification of UE location

Example embodiments provide an improvement in verifying a location of a communications device (UE) in order to provide location-based services to the UE. The location-based services comprise, for example, determining a location of the UE by the network in order for the network to provide services specific to the UE's location. Likewise, an application programme running on the UE may provide certain services, having either determined the location of the UE or having been provided with a determined location of the UE. As will be appreciated, such location-based services depend on an accurate determination of a location of the UE. However, a technical problem is to improve a determination or verification of the location of a UE which is being served by an NTN.

In an example, a network operator is required to cross check a UE location reported by the UE in order to fulfil certain regulatory requirements (e.g. lawful intercept, emergency call, public warning system or the like). As such, a network is required to verify a UE's location to check that the UE's reported location information is accurate (e.g. by estimating the UE's location at the network side). Furthermore, it was identified within, for example, [3], that, to support regulated services and features such as public warning systems, charging and billing, emergency calls, lawful intercept, data retention policy in cross-border scenarios and international regions, and network access, 3GPP networks should have the capability to locate each UE in a reliable manner and determine a policy that applies to that UE's operation depending on its location. It is also suggested that a position determined and generated by the UE through, for example, its global navigation satellite system (GNSS) capability cannot necessarily be trusted by the network operator.

It is also stated in [3] that accuracy requirements for the UE location vary by application, for instance:

TABLE 1
UE location requirements for different location applications

| Use case | Accuracy requirement |
|---|---|
| Emergency call | 50 m |
| Lawful intercept | Approx. 2 km |
| Public warning system | Approx. 2 km |
| Charging and tariff notifications | Approx. 2 km |
| (determination of which country the UE is | |
| in or the country/aeronautical/maritime | |
| status of the UE) | |
| Country of UE location | A few kms (size of |
| | terrestrial cell) |

It should be noted that the accuracy in the above table for the lawful intercept, public warning system, and charging and tariff notifications, that is 2 km, is equivalent to the accuracy obtainable in a terrestrial network using positioning through Cell ID, and that the applications may come with other requirements besides location accuracy. For example, the emergency call application may require a latency to be lower than for other applications. The latency requirement may be such that the setting up of the emergency call should not be delayed by location requirements [3]. It should also be noted that the accuracy requirement of the emergency call procedure, that is, 50 m, may not in some circumstances be achieved. Likewise, the latency requirement that the setting up of the emergency call be not delayed may not always be achieved. More information can be found in references [2], [3], [4], [5], and [6], which contain further details on the need for network verification of the UE location.

According to [8], emergency calls (e.g. E-911/E-912) may not form part of the requirements for network verification of UE location.

Note that the accuracy requirement applies to the UE location report (i.e. the claimed location of the UE) and does not necessarily apply to the verification of the UE location by the network. For example, the UE location can be verified with a lower accuracy than the accuracy of the UE location report itself. For instance, in the case of an emergency call, the UE may report a location of the emergency (e.g. the GNSS location of a crime scene). The location verification by the network may then verify that the UE is located in a certain town in a certain country, but does not verify the UE location to the precision of GNSS location, for example. The verification information is nonetheless sufficiently precise to ensure the emergency call is routed to the appropriate emergency control room and the appropriate emergency responder is sent (e.g. to help ensure emergency services belonging to one region respond to a reported incident in that region rather than, say, the emergency services belonging to a neighbouring region).

### Observed Time Difference of Arrival (OTDOA)

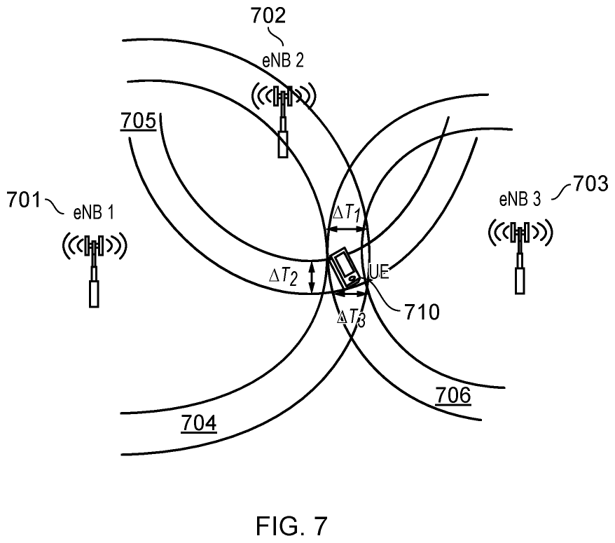

One positioning technique used in LTE and NR (and considered for IoT (i.e. eNB-IoT and fe-MTC (further enhanced-MTC)) is Observed Time Difference of Arrival (OTDOA). This is a technique in which a location of a UE is determined from measurements of a time for signals to propagate between the UE and a plurality of gNBs (gNodeBs)/eNBs (eNodeBs), from which the location of the UE can be determined by triangulation. This is shown graphically in FIG. 7, which depicts three eNBs numbered 701, 702, and 703, and a UE 710.

A basic operation of calculating time of arrival (TOA) from each eNodeB can be described as follows:
1. First, a UE receives reference signals and then performs cross-correlation with locally generated reference signals.
2. Cross-correlation from different sub-frames can be accumulated so that good cross-correlation peaks can be obtained.
3. A measured time delay can be obtained from an estimated power delay profile (PDP).
4. The above steps are repeated to obtain measured time delays from several eNodeBs (e.g. reference eNodeB and neighbour eNodeBs).
5. Reference Signal Time Difference (RSTD) measurement is obtained by subtracting the measured time delay of neighbour eNodeBs from the measured time delay of the reference (serving) eNodeB. The UE may send all of the RSTD measurements and an RSTD measurement quality to a location server, or may process the RSTD measurements itself to determine its location.

In FIG. 7, the UE 710 may measure a Reference Signal Time Difference (RSTD), i.e. an observed time difference between a target eNB and a reference eNB. In this example, the UE 710 would measure RSTD for two or more eNBs, for example eNB2 702 and eNB3 703 (i.e. involving three or more eNBs since one of them is the reference eNB, in this example eNB1 701) and may then process the RSTD measurements or send these RSTD measurements to a Location Server (not shown). The Location Server, on receiving the RSTD measurements, may calculate a UE position based on these RSTD measurements using known locations of the eNBs involved. That is, the Location Server performs a triangulation (involving at least three eNBs) to determine the UE 710 position as shown in FIG. 7. A time difference report containing the RSTD measurements, to be sent to the Location Server, may be a conventional Reference Signal Time Difference (RSTD) report as specified for 3GPP LTE and NR system(s).

Accuracy of the UE 710 position is dependent upon an accuracy of the RSTD measurements. For example, in FIG. 7, a time of arrival from eNB1 has an accuracy of ΔT₁, as signified by a band 704, representing a possible variation on measured relevant propagation difference from the base station, which in this example is the eNB1 701. Likewise, a time of arrival of eNB2 has an accuracy of ΔT₂, as represented by a corresponding band 705, and a time of arrival for eNB3 has an accuracy of ΔT₃, similarly being represented by a band 706. The UE 710 is located at an intersection of these bands, determined by a time difference and hence a propagation distance from each of the base stations 701, 702, 703 transmitting to the UE 710. An accuracy of a time of arrival measurement is dependent upon a quality of the measured Reference Signal and a bandwidth of the Reference Signal.

For greater accuracy, corresponding measurements may be taken of a time difference of arrival of further signals from additional base stations not represented here. It will be appreciated that the signals transmitted by the base stations (eNBs 701, 702, 703) may or may not be simultaneous; if not simultaneous then an offset of the base stations transmission times, or alternatively times of individual transmissions according to some shared time keeping system, may be provided to the UE to assist its calculation of the UE location.

A time of arrival can be estimated using a known signal, i.e. Reference Signals (RSs) such as a Cell-specific Reference Signal, CRS, Primary Synchronization Signal, PSS, or Secondary Synchronization Signal, SSS. However, these RSs experience inter-cell interferences and hence, in 3GPP Release 9, Positioning Reference Signals (PRS) are introduced.

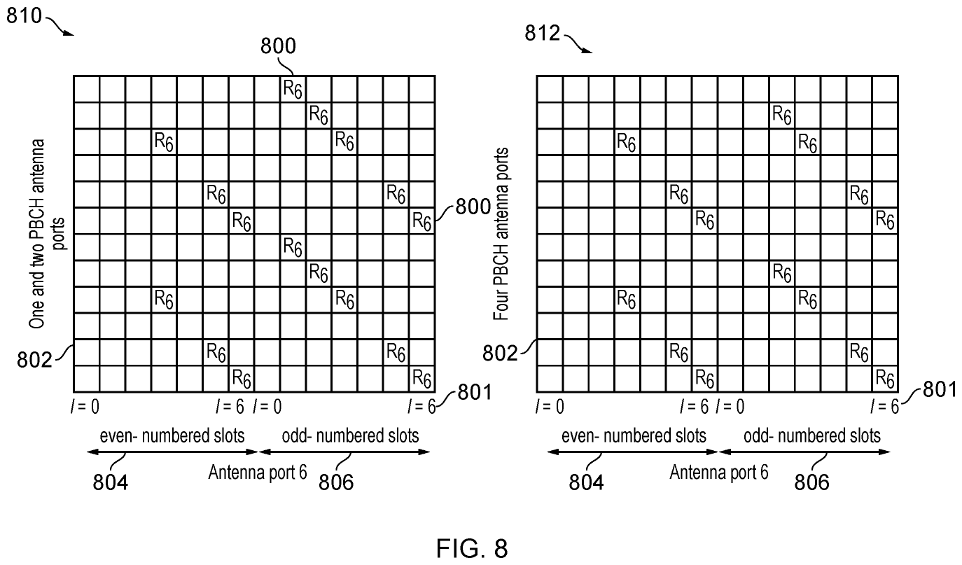

FIG. 8 shows an RE (Resource Element) location of a set of PRS for an eNB within a Physical Resource Block, PRB, and a location occupied is dependent upon an eNB's Cell ID. Up to six different sets of PRS locations with different frequency shifts can be transmitted, hence up to six different eNBs can be measured at a time assuming one eNB per frequency shift. Note that eNBs sharing a same frequency shift have different sequences to distinguish between themselves.

Specifically, FIG. 8 shows an example configuration of PRS locations R₆ 800 within a grid of possible time-frequency resource elements, the grid being a representation of OFDM symbols on an x-axis 801 and sub-carriers on a y-axis 802 defining resource elements as individual carriers. The OFDM symbols are grouped into slots 804, 806 comprising seven OFDM symbols. As shown in FIG. 8, two such grids are shown, one on a left side for one or two PBCH antenna ports 810 and one on a right side for four PBCH antenna ports 812. These two examples 810, 812, show different configurations that may be implemented, and are intended, though not limited, to represent the configurations employed corresponding to different numbers of antenna ports.

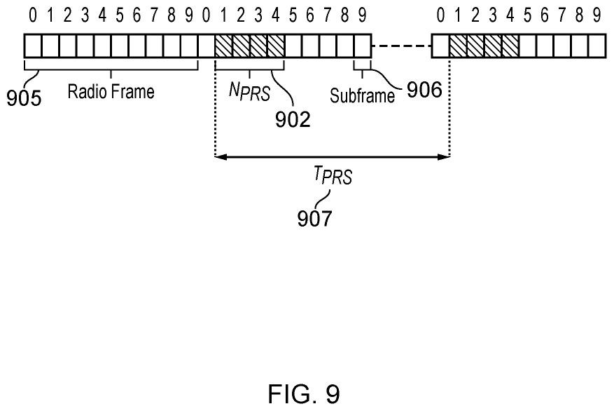

Furthermore, FIG. 9 provides an additional representation regarding a location of positioning reference signals within frames broadcast by a base station. A set of consecutive subframes 902 are reserved for a transmission of positioning reference signals, which are repeated with a periodicity T_{PRS} 907.

The PRS is transmitted over N_{PRS}={1, 2, 4, 6} consecutive subframes with a period of T_{PRS}={160, 320, 640, 1280} subframes. The N_{PRS} consecutive subframes of PRS transmission is known as a Positioning Occasion. An example of the Positioning Occasion and the period T_{PRS} are shown in FIG. 9, where the Positioning Occasion has length N_{PRS}=4 subframes and occupies subframe 1, 2, 3 & 4.

For the sake of completeness, further information will now be given about a process of a UE determining its location through an uplink time difference of arrival method, which, as described later, may be adapted to be implemented in accordance with several embodiments of the present disclosure.

### Uplink Time Difference of Arrival

3GPP NR also supports UTDOA (Uplink Time Difference of Arrival) and other positioning methods, as described in [4].

In Uplink Time Difference of Arrival (UTDOA), a communications device transmits an uplink signal such as a Sounding Reference Signal (SRS) that is received by multiple infrastructure equipment. The SRS (uplink pilot) transmitted from the UE may arrive at different ones of the infrastructure equipment at different times. The infrastructure equipment (which may be synchronised to each other, for example using a time derived from a GPS receiver) determine these times of arrival and may send these times of arrival to a location server. The location server calculates a location of the communications device based on multilateration.

It is well known in the art that a UE can determine its location by using a Global Navigation Satellite System (GNSS) such as GPS, GLONASS, or another suitable system. These systems, in a simplified way, work on a basis of triangulation of the device with respect to a plurality of satellites (typically four satellites are required) to determine a location of a receiving device such as the UE. However, it is desirable that a network should have some way of determining the location of the UE independent of the UE reporting its position. If there are errors in the calculation of a UE's location, the difference between a UE's calculated location and its actual position may increase over time, causing substantial errors and leading to significant problems.

As mentioned below, it may also be desirable to verify a UE's reported location in order to help prevent UE location spoofing.

### Potential NTN Positioning Methods

A recent discussion [7] identified various candidate NTN positioning methods for a determination of a UE location in an NTN network. These methods include:
RAT-dependent positioning techniques, based on similar terrestrial network techniques, such as:
   Downlink Time Difference of Arrival, DL TDOA, also known as Observed TDOA, OTDOA
   Uplink Time Difference of Arrival, UL TDOA or simply UTDOA
   Round Trip Time, RTT
   Angle-based positioning methods (angle of arrival, AoA, angle of departure, AoD).
RAT-independent positioning methods, based on terrestrial network techniques, such as:
   Global Navigation Satellite Systems (GNSS)
   Assisted GNSS (A-GNSS)
   Terrestrial Beacon Systems (TBS)

In [4] it is observed that several terrestrial positioning techniques could be adapted to support verification of UE location using a single or multiple satellites. There are also a number of other techniques used to determine locations of UEs in terrestrial networks, such as sensors, WLAN, Bluetooth, Enhanced Cell ID (E-CID), the first three being dependent on external systems/sensors and network assistance, and E-CID being a legacy E-UTRA (Evolved UMTS (Universal Mobile Telecommunications System) Terrestrial Radio Access) positioning method. Several of these are being adapted for use in future NR standards.

Current 3GPP specifications define functionality for identifying an absolute location of a UE which is configured to operate in accordance with those specifications, and in communications with a wireless communications network operating according to those specifications. RTT uses measurements of a round-trip time of signals between the UE and multiple infrastructure equipment to determine a distance between the UE and each of the multiple infrastructure equipment, from which a location corresponding to the UE can be derived.

The above techniques, as well as OTDOA and UTDOA, rely on a measurement (of a signal strength and/or of a relative time of arrival) of signals transmitted by the UE and received at infrastructure equipment of the wireless communications network or of signals transmitted by infrastructure equipment and received at the UE.

Further details of 3GPP positioning methods are provided in [9], for example.

A UE may determine its location via various RAT-independent means, such as GNSS (as discussed above). These location methods are known as being accurate. The role of network verification of UE location is thus not to compete with traditional positioning methods, such as GNSS, but to verify a location of the UE reported by the UE to the network.

### Number of Measurements Required to Verify UE Location

GNSS techniques such as GPS require four measurements in order to determine the {latitude, longitude, altitude} of a UE. Determining a GPS location requires the following steps:
UE receives reference signals from four or more satellites
UE calculates an RSTD (reference signal time difference) from each of the satellites.
Knowing a location of each of the satellites (via ephemeris information) and a synchronisation state of the satellites (e.g. that the satellites are synchronised), the UE can multilaterate in order to determine its location. In some situations, if the satellites are not synchronised, the UE may offset the RSTD of some or all of the satellites based on a known timing difference between the satellites.

In contrast, for UE location verification, it may not be necessary to determine an altitude of the UE. In this case, {latitude, longitude} can be determined with three measurements. UE location verification hence requires fewer measurements than position determination, and, as previously mentioned, may not need to be determined to the same level of precision as a UE location determined by the UE itself (e.g. via GNSS). In NTN systems, at any one time, the UE may only be able to see a single (or limited number of) satellites. This makes it difficult to perform traditional OTDOA or UTDOA positioning methods for the purposes of UE location verification. A RAT-dependent UE-location verification method that can operate with a single satellite is hence desirable. It is also desirable that the UE location verification method works for a variety of UE speeds, for example, up to 500 km/hour. Some examples UE location verification methods based on a single satellite are described below.

### Measuring DL Positioning Signals From the Satellite at Different Times

A Low Earth Orbit (LEO) satellite traverses the sky rapidly. For example, when in a 600 km altitude orbit, a LEO satellite moves at 7.56 km/second. Therefore, if positioning reference signals with reference to a same satellite are measured at different times, resulting reference signal measurements will be taken with the same satellite at different positions in the sky.

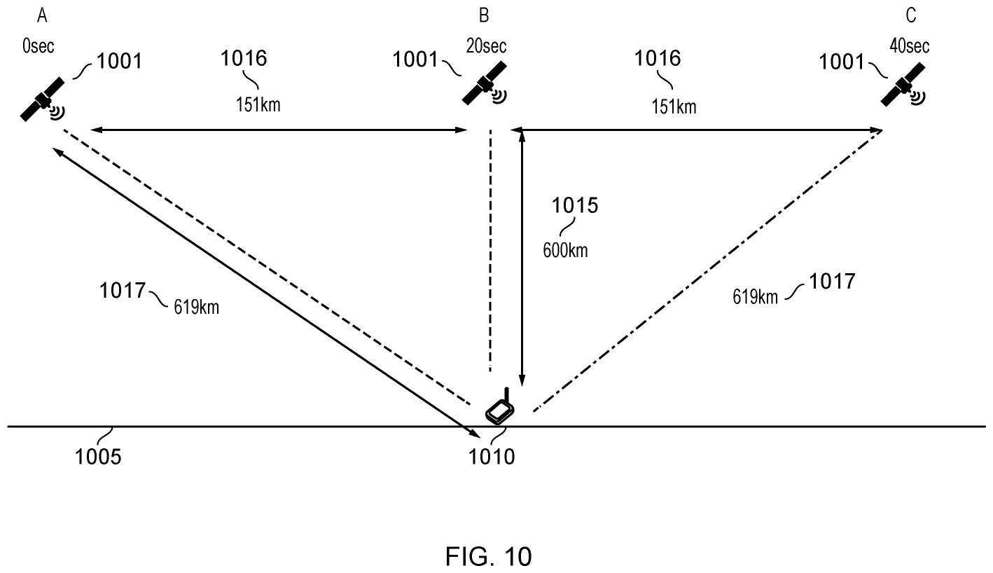

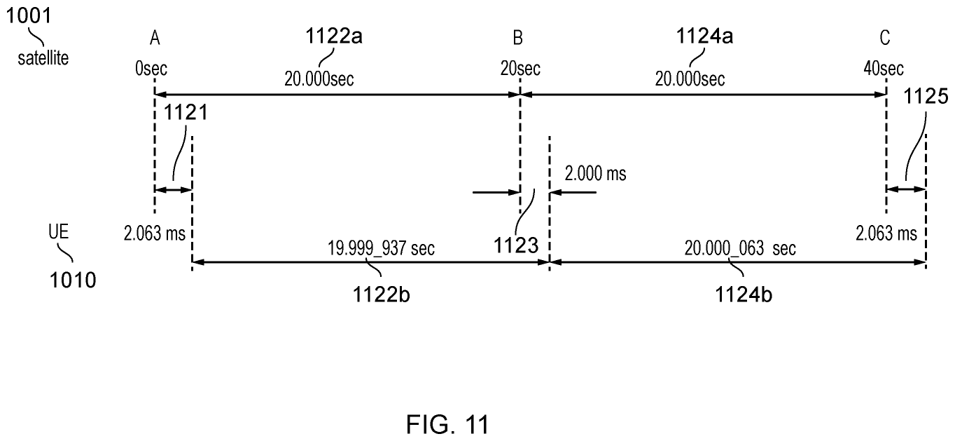

FIG. 10 shows a simplified representation of the satellite 1001. The satellite 1001 is a LEO satellite with the configuration of satellite 602 or 626 exemplified in FIG. 6, for example. Distances 1017, 1015, 1017 between the satellite and a UE 1010 are shown at different times as the satellite moves from position A to position B to position C (note the UE 1010 may have the configuration of UEs 14 or 306, the UEs 14 and 306 being functionally identical). The LEO satellite 1001 in this example operates at an altitude of 600 km. As noted above, a LEO satellite in such an orbit travels at 7.56 km/second and hence moves a distance 1016 of 151 km in 20 seconds. Hence, a distance between the satellite and UE varies from 619 km to 600 km (by trigonometry) when the satellite moves from position A to position B over a time period from 0 to 20 seconds and, similarly, varies from 600 km to 619 km when the satellite moves from position B to position C over a time period from 20 to 40 seconds.

For simplicity, it is considered that the UE is on the surface of the earth 1005, which is modelled as a flat plane, and that any motion of the UE is negligible relative to the movement of the satellite over a given time period. The movement and distances shown are also represented as linear. In reality, the satellite will move in an arc and the Earth's surface will be an arc. However, the principles of the present technique can be demonstrated with sufficient accuracy using the simplified linear representation of FIG. 10.

By approximating the speed of light as 3×10⁸ m/s, a time of flight for a signal from the satellite to the UE, corresponding to a transmission distance of 619 km, 600 km, and 619 km respectively, at the various times can be calculated to be:
A (0 seconds): 2.063 ms
B (20 seconds): 2.000 ms
C (40 seconds): 2.063 ms

FIG. 11 shows a representation of a timing of messages, times of transmission for messages by the satellite 1001, and corresponding times of arrival at the UE 1010 of DL reference signals (e.g. 3GPP Release 9 Positioning Reference Signals (PRS)) that are transmitted by the satellite 1001 at times 0, 20 seconds, and 40 seconds (corresponding to positions A, B and C, respectively). The times of arrival at which the DL reference signals are received at the UE 1010 are delayed, relative to transmit times at the satellite 1001, due to the varying propagation times that are shown in FIG. 11.

At position A, the satellite 1001 transmits a first DL reference signal to the UE 1010 and a delay 1121 is 2.063 ms as shown above. After a wait time 1122a of 20 seconds, by which time the satellite has moved to position B, the satellite transmits a second DL reference signal to the UE 1010. Position B is closer to the UE 1010 than position A (by 19 km) and thus the propagation delay 1123 is lower at 2.000 ms. After another wait time 1124a of 20 seconds, by which time the satellite has moved to position C, the satellite transmits a third DL reference signal to the UE 1010. Position C, like position A, is further from the UE 1010 than position B (by 19 km) and thus the propagation delay 1125 is again higher at 2.063 ms.

Based on reception times of these signals, the UE reports, to the network (e.g. via the satellite 1001 or via a terrestrial TRP 10) the following interarrival times 1122b, 1124b of the first and second DL reference signals (denoted AB) and the second and third DL reference signals (denoted BC):
AB: 19.999937 seconds
BC: 20.000063 seconds

The exact form of signaling used may be different. For example, the UE can signal a difference (delta) of the interarrival times from an inter-transmit time of 20 seconds. That is, the UE can report times of {AB: −0.063 ms, BC: +0.063 ms}, for example.

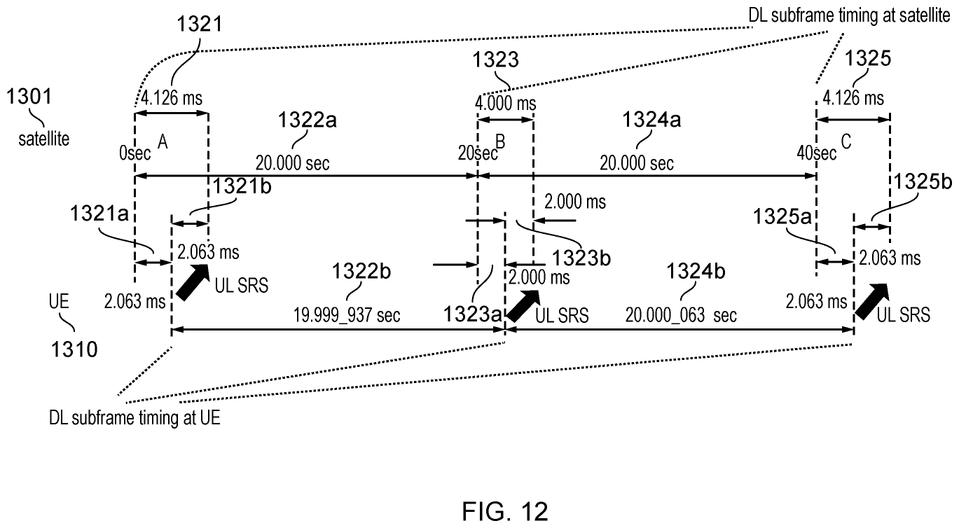

The network can calculate a location of the UE based on a known position of the satellite at the different transmit times of the DL reference signals, that is, at positions A, B, and C, and the time difference of arrival of the DL reference signals, wherein a relevant TDOA in the example shown in FIGS. 11 and 12 is {AB: −0.063 ms, BC: +0.063 ms}. Methods of calculation of UE position based on time difference of arrival and known gNB locations are known from currently specified DL-OTDOA techniques for terrestrial networks. The network is therefore able to verify the location reported by the UE (e.g. based on GNSS measurements).

Examples of the DL reference signals (also referred to as DL positioning signals or DL positioning reference signals) may include:
Positioning Reference Signal, PRS
Channel State Information Reference Signal, CSI-RS
Synchronization Signal Block, SSB

This positioning method may be used with more than one satellite, provided the network knows a timing of the DL reference signals of each satellite and location of each satellite.

### Measuring UL Positioning Signals From the UE at Different Times

UL TDOA techniques (or round trip time, RTT, measurements techniques) can also be used, wherein a UE transmits some UL reference signals (also referred to as UL positioning signals or UL positioning reference signals), such as a Sounding Reference Signal, SRS, on an UL channel, such as a Physical Random Access Channel, PRACH, and a network measures a time of arrival of these UL reference signals at a satellite. RTT techniques offer improved resilience to an issue of clock drift at the UE, since time difference of arrival of the UL reference signals can be measured even when a UE's clock is synchronized to DL frame timing.

An example of an operation of UE location verification using UL reference signals and RTT techniques is shown in FIG. 12. FIG. 12 is again based on the scenario shown in FIG. 10 (with the satellite 1001 now being denoted as satellite 1301 and the UE 1010 now being denoted as UE 1310)

In FIG. 12, the UE 1310 is instructed to send an UL SRS at a known time relative to DL subframe timing. For the sake of simplicity, it can be considered that the UE 1310 is required to send to the satellite 1301 UL SRS immediately after downlink subframe boundaries that occur at times 0, 20 seconds and 40 seconds. The UE 1310 knows when these DL subframes boundaries occur based on signaling of system frame number (SFN) and the UE 1310 being able to count subframes. The following transmissions and measurements occur:
With respect to position A, a DL subframe timing at the UE 1310 is 2.063 ms later than a DL subframe timing at the satellite 1301 due to a time of flight delay between the two 1321a. At the UE's DL subframe timing, the UE 1310 sends UL SRS. Since the UE's DL subframe timing is 2.063 ms late compared to the DL subframe timing at the satellite 1301, the UL SRS is transmitted 2.063 ms later than the satellite's DL subframe timing. The UL SRS is subject to a further propagation delay 1321b of 2.063 ms and hence arrives at the satellite 1301 4.126 ms after the satellite's DL subframe timing. The satellite 1301 thus measures a delay 1321 of 4.126 ms for the UL SRS reception, which represents a round trip time between the satellite 1301 and the UE 1310. Hence, a propagation delay between the satellite 1301 and UE 1310 can be calculated as 4.126/2=2.063 ms, which equates to a distance of 619 km. Following this, the satellite 1301 (e.g. in the case of a regenerative satellite) can send this data to a network, for instance to a gNB or other base station that controls the satellite 1301 and the transceiver functionality of the satellite 1301, and thus the network then knows that the UE 1310 is 619 km away from a location of the satellite 1301 at time 0 seconds. The network knows the location of the satellite 1301, for example from signaling from a satellite ground station or from orbital calculations. Alternatively (e.g. in the case of a transparent satellite), the (ground-based) gNB transmits signals to and receives signals from the satellite (in particular, the UL SRS signal) and compensates for the known distance between the gateway and the satellite to determine the propagation delay between the satellite 1301 and UE 1310 (and thus the distance between the satellite 1301 and UE 1310 when the UL SRS signal was transmitted).
For position B, a similar RTT calculation to that undertaken at position A is done. At position B, the satellite 1301 is closer to the UE 1310 (e.g. directly overhead) and the RTT is therefore lower. At position B, the RTT 1323 is measured as 4.000 ms, from an addition of a time 1323a of 2.000 ms by which the UE's DL subframe timing trails the satellite's DL subframe timing and a time of flight 1323b of 2.000 ms between the satellite 1301 and the UE 1310. This equates to a distance of 600 km between the UE 1310 and satellite 1301 (which may be calculated using UTDOA based on the 2.000 ms time of flight time). Incidentally, a time 1322b between transmissions of the UL SRS by the UE when the satellite is at positions A and B is 19.999937 seconds (compared to a time 1322a of 20.000000 seconds between the DL subframe timings at the satellite).
This is repeated at position C. At position C, the satellite 1301 is the same distance from the UE 1310 as at position A. At position C, the RTT 1325 is thus again measured as 4.126 ms, from an addition of a time 1325a of 2.063 ms by which the UE's DL subframe timing trails the satellite's DL subframe timing and a time of flight 1325b of 2.063 ms between the satellite 1301 and the UE 1310. This equates to a distance of 619 km between the UE 1310 and satellite 1301 (which may be calculated using UTDOA based on the 2.063 ms time of flight time). Incidentally, a time 1324b between transmissions of the UL SRS by the UE when the satellite is at positions B and C is 20.000063 seconds (compared to a time 1324a of 20.000000 seconds between the DL subframe timings at the satellite).
Based on (1) measured distances between the UE 1310 and satellite 1301 at the times corresponding to positions A, B and C and (2) the known locations of the satellite at these times, the network can determine the location of the UE 1310. The network is therefore able to verify the location reported by the UE (e.g. based on GNSS measurements).

### Incomplete Ephemeris Information

As discussed, it may be desirable for the network to be able to verify the location of a UE reported by that UE. This is because a UE may report its location incorrectly. This may be referred to as spoofing and may be carried out for fraudulent reasons, for example. For instance, a UE may be made to spoof its location to fraudulently obtain services only available in certain locations (e.g. certain countries) when the UE is not actually in such a location. A suitable verification function which is able to corroborate the UE location reported by the UE is therefore desirable.

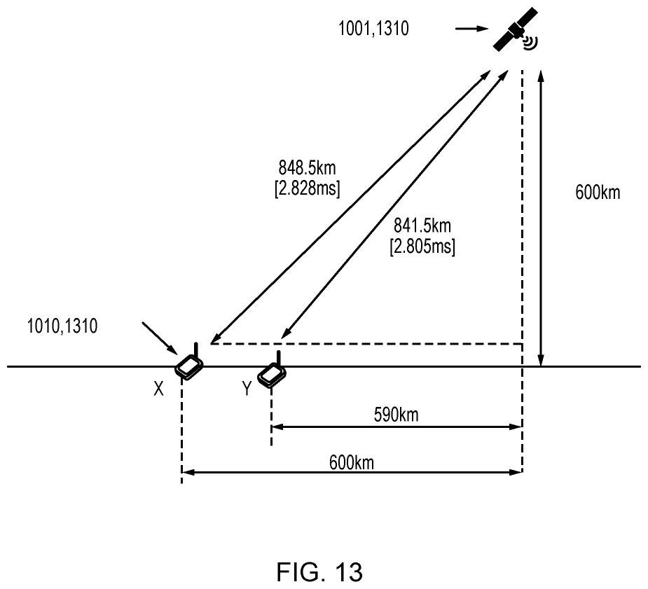

A UE may spoof its location in the scenarios described above by providing modified location verification information (verification information) to the network. For example, if the UE is actually in location X and fraudulently reports that it is in location Y, the UE can adjust the verification information provided to the network such that it appears to be at location Y. This is exemplified in FIG. 13.

For example, for the scenarios of FIGS. 11 and 12, the UE 1010 or 1310 knows the location of the satellite 1001 or 1301 from ephemeris information of the satellite broadcast by the network and it knows the location Y that it is falsely reporting as well as its true location X. The UE may then calculate the propagation time from the known satellite location to location Y.

For example, for the scenario of FIG. 11, the UE may report verification information that is consistent with location Y. Thus, for example, referring to FIG. 13, the UE reports verification information associated with a propagation delay of 2.805 ms instead of a propagation delay of 2.828 ms.

In another example, for the scenario of FIG. 12, the UE may timing advance or delay the SRS (sounding reference signal) transmission such that it arrives at the satellite with a delay that is consistent with location Y. Thus, for example, referring to FIG. 13, the UE may timing advance the transmission of SRS by 2.828−2.805=0.023 ms such that it appears that the propagation delay is 2.805 ms rather than 2.828 ms.

It is noted that, in terms of actual communication (as opposed to generating spoofed verification information), the UE applies a UE-specific timing advance and frequency compensation (to deal with Doppler shift) based on its actual location X rather than its spoofed location Y.

There are hence potentially cases like the examples above in which a UE is able to provide incorrect measurements or signals for the location verification procedure in order to spoof its location. It is hence desirable to address this problem.

In examples of the present technique, ephemeris information transmitted to UEs in system information is incomplete. The incompleteness of the ephemeris information means that the UE is unable to make an accurate determination of satellite location. As the UE does not know the satellite location precisely, it is unable to spoof measurements that are used for location verification. For example, referring again to FIG. 13, if the UE does not know the precise location of the satellite, it cannot reliably determine the propagation delay associated with location Y when it is not actually located at location Y and therefore cannot spoof the verification information associated with location Y. Only once the UE location is verified is the UE then sent complete ephemeris information via dedicated signalling, thereby allowing the UE to more robustly communicate with the NTN (non-terrestrial network). Ephemeris information may be broadcast in system information or signalled to a UE using dedicated signalling, as discussed in [10], for example.

In an example, the broadcast ephemeris information of the satellite is incomplete through being imprecise and/or inaccurate. That is, only a portion of the correct ephemeris information is provided. The remaining portion of the broadcast ephemeris information is either not broadcast (so the broadcast ephemeris information is imprecise, that is, not sufficiently precise for the satellite's location to be determined by the UE to enable the UE to spoof its location) or the remaining portion is broadcast with deliberate inaccuracies (so the broadcast ephemeris information is inaccurate, that is, not sufficiently accurate for the satellite's location to be determined by the UE to enable the UE to spoof its location). In either case, the UE cannot determine the satellite location with sufficient accuracy to enable it to calculate false verification information (e.g. the verification information associated with position Y when the UE is actually located at position X). Imprecise ephemeris information comprises, for example, a smaller number of bits than is necessary to signal the satellite location. Inaccurate ephemeris information comprises, for example, the necessary number of bits to signal the satellite location but with a portion of those bits (e.g. the highest precision/least significant bit(s) (LSBs) and/or a portion of those indicating the epoch time) randomly changed to falsify the true location of the satellite.

Once the UE location has been verified during an initial access phase based on the incomplete broadcast ephemeris information, the UE is provided with complete ephemeris information via dedicated signalling. The complete ephemeris information is the original ephemeris information (that is, without modification to make it inaccurate or imprecise) which enables the UE to accurately determine the satellite location. This is distinguished from the incomplete ephemeris information which is initially broadcast, the broadcast ephemeris information being incomplete in that it comprises only a portion of the original ephemeris information. The remaining portion has either been removed or replaced with inaccurate information.

Thus, for example, when the ephemeris information is incomplete, a UE cannot falsely adjust the reported DL (downlink) propagation delay (e.g. in the scenario of FIG. 11) or the timing of UL (uplink) signals (e.g. in the scenario of FIG. 12) to operate based on a spoofed location Y. This is because, while the UE knows its purported location Y, it does not know the location of the satellite accurately enough to adjust the reported DL propagation delay or UL signal timing to correspond to location Y.

Note that the reported DL propagation delay and UL signal timing are both examples of verification information associated with the UE. Verification information in the form of the reported DL propagation delay may be comprised in a signal transmitted to the network by the UE. Verification information in the form of the timing of UL signals is implicit in the transmission and/or reception times of the UL signals transmitted to the satellite by the UE. In any case, the verification information is indicative of the distance between the UE and satellite based on the propagation time of DL and/or UL signal(s) transmitted between the UE and satellite.

The network, however, does know the accurate satellite location and the reported UE location. The network can thus verify that the verification information associated with the UE (e.g. the reported propagation delay or UL signal timing) is consistent with the UE's reported location. Since the verification information at, for example, location Y, cannot be spoofed by a UE not actually at location Y (due to the incomplete broadcast ephemeris information of the satellite), this enables a more reliable verification of the UE's reported location by the network.

In an example, information transmitted by the UE which is used for UE location verification by the network (e.g. reported propagation delay and reported UE location) is transmitted by dedicated RRC (radio resource control) signalling. This helps preserve the security/reported privacy of this information. If the verification information associated with the UE and the reported UE location are consistent (indicating the UE is truthfully reporting its location), the UE is provided with the complete ephemeris information. On the other hand, if the verification information associated with the UE and the reported UE location are not consistent (indicating the UE may be falsely reporting its location), the network may drop the RRC connection.

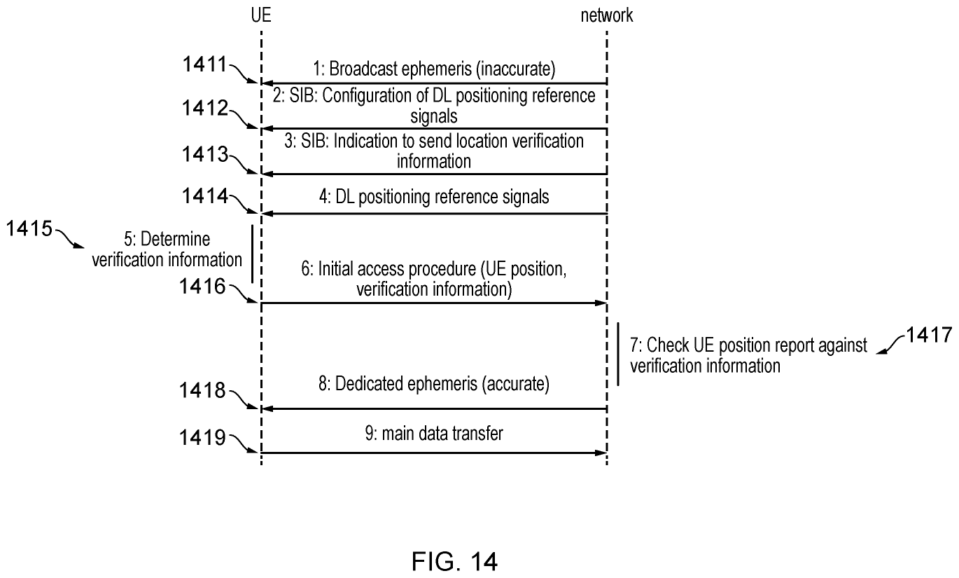

FIG. 14 shows an example operation when UE location verification by the network is based on timing measurement of DL (downlink) signals (e.g. as exemplified in the scenario of FIG. 11). Where applicable, the steps may occur in a different order to that shown.

At step 1411, the network broadcasts incomplete ephemeris information. For example, the incomplete ephemeris information is sufficient to enable transmission of signalling messages between the UE and satellite but not sufficient to enable accurate satellite positioning.

At step 1412, the network signals the configuration of the DL positioning signals to be used for network verification of UE location. This signalling is carried in system information, for example.

At step 1413, the network signals an indication that location verification information has to be included in the RRC Setup Request message. This signalling is carried in system information, for example.

In an example, the indication of step 1413 may be transmitted in another step of the initial access procedure. For example, an indication that location verification is required may be transmitted in Msg2 (a Random Access Response (RAR) message). Furthermore, the configuration of the DL positioning signals at step 1412 may be signalled differently, for example in Msg2 of the initial access procedure (the DL positioning signals themselves are therefore transmitted after Msg2 or Msg4, respectively, in these cases).

In an example, a single system information block may carry all of (1) the incomplete ephemeris information, (2) the configuration of the DL positioning signals and (3) the indication that location verification information has to be included in the RRC Setup Request message.

At step 1414, the network sends DL positioning reference signals (e.g. as exemplified in FIG. 11). These allow the UE to perform measurements on the received timing of the DL positioning signals in order to create verification information that can be sent to the network.

At step 1415, the UE determines the verification information. For example, the UE measures the time of arrival of the DL positioning reference signals and uses this to determine the interarrival times between successive DL positioning reference signals (e.g. AB: 19.999937 seconds/−0.063 ms, BC: 20.000063 seconds/+0.063 ms in FIG. 11) as the verification information.

At step 1416, as part of the UE initial access procedure, the UE signals its position and the verification information. These pieces of information are signalled, for example, in an RRC Setup Request message that is sent as Msg3 of the initial access procedure. The UE location is determined by the UE from a global navigation satellite system (GNSS) measurement, for example, and is the location that is to be verified with the verification information.

At step 1417, the network checks that the UE position report is consistent with the verification information. Since the UE does not yet have the complete ephemeris information, the UE cannot know the correct verification information to send unless it is genuinely located at its reported position.

If the reported UE position and the verification information are consistent, the network signals the complete ephemeris information (or, at least, the portion of the complete ephemeris information not previously broadcast) to the UE at step 1418. The complete ephemeris information is sent to the UE using dedicated RRC signalling, such as in an RRC message such as RRC Setup. In an example, the complete ephemeris information is sent once a secure connection between the UE and network has been established. This enables, for example, the complete ephemeris information to be ciphered and only decodable by the specific UE for which the RRC connection has been established, thereby preventing other UEs from decoding the complete ephemeris information.

At step 1419, once the UE has the complete ephemeris information, the UE and network commence the main data transfer.

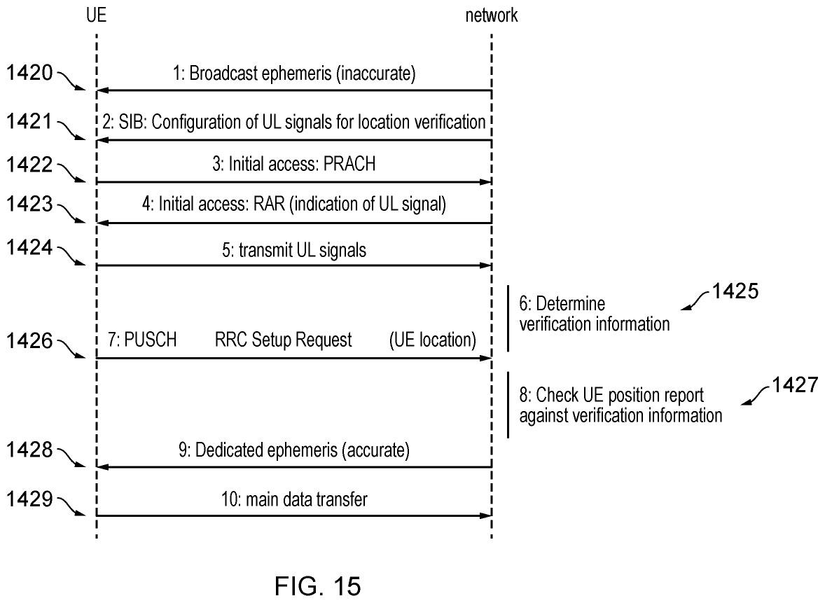

FIG. 15 shows an example operation in which UE location verification is based on measuring the timing of UL signals transmitted by the UE (e.g. as exemplified in the scenario of FIG. 12). Where applicable, the steps may occur in a different order to that shown.

At step 1420, the network broadcasts the incomplete ephemeris information. Again, for example, the incomplete ephemeris information is sufficient to enable transmission of signalling messages between the UE and satellite but not sufficient to enable accurate satellite positioning.

At step 1421, the network signals the configuration of the UL signals that are to be used for network UE location verification. This signalling may be carried in system information (as shown), for example, but may also be transmitted later in the message sequence, such as within the RAR of step 1423. Transmitting the UL signal configuration in system information rather than within the RAR means the size of the RAR message can be reduced (for example, this allows the RAR to indicate an index of an UL signal that the UE should transmit rather than the whole configuration of the UL signal).

At step 1422, the UE starts the initial access procedure by transmitting a PRACH (physical random access channel) preamble.

In an example, a single system information block may carry (1) the incomplete ephemeris information and (2) the configuration of the UL positioning signals.

At step 1423, the network sends a RAR message to the UE in response to receiving the PRACH preamble. When the UL signals are configured in step 1421 using system information, for example, the RAR message indicates which of these previously configured UL signals the UE should transmit. The RAR may also indicate the resources (for example time and frequency resources) assigned for the transmission of the UL signals (e.g. if these are not indicated at step 1421).

The assigned resources for the UL signal transmission may be located over a sufficient period of time in order to allow the satellite to move a sufficient distance between times at which the UL signals are transmitted. This allows for accurate multilateration of UE location. For example, the UE may be assigned resources to transmit UL signals at time 0 seconds, 20 seconds and 40 seconds (as exemplified in the scenario of FIG. 12).

At step 1424, the UE transmits the UL signals that were previously configured and assigned.

At step 1425, the network determines verification information based on the transmitted UL signals. As exemplified in FIG. 12, there is sufficient time between the UL signal transmissions (e.g. approximately 20 seconds) to allow the satellite to fly a sufficient distance between transmissions, thereby helping provide accurate multilateration.

At step 1426, the UE transmits Msg3 of the initial access procedure. This message may contain an RRC Setup Request indicating the UE location (e.g. a UE position report). Again, the UE location is determined by the UE from a GNSS measurement, for example, and is the location that is to be verified with the verification information.

Note, in another example, step 1426 may occur before steps 1424 and 1425.

At step 1427, the network checks for consistency between the UE position report (received at step 1426) and the verification information that was determined from the UL signal timing (at step 1425).

If the reported UE position and the verification information are consistent, the network signals the complete ephemeris information (or, at least, the portion of the complete ephemeris information not previously broadcast) to the UE at step 1428. The complete ephemeris information is sent to the UE using dedicated RRC signalling, such as in an RRC message such as RRC Setup. In an example, the complete ephemeris information is sent once a secure connection between the UE and network has been established. This enables, for example, the complete ephemeris information to be ciphered and only decodable by the specific UE for which the RRC connection has been established, thereby preventing other UEs from decoding the complete ephemeris information.

At step 1429, once the UE has the complete ephemeris information, the UE and network commence the main data transfer.

There are various forms the incomplete and complete ephemeris information may take.

In an example, the precision of the broadcast incomplete ephemeris information is limited. For example, the incomplete ephemeris information may comprise only a predetermined number of the most significant bits of the ephemeris information (that is, the most significant bit, second most significant bit, third most significant bit and so on, up to and including the predetermined number of most significant bits). The complete ephemeris information transmitted by dedicated signalling then comprises the remaining, least significant bits of the ephemeris information. The ephemeris information consists of multiple parameters, where the parameters depend on the format of the ephemeris information. The ephemeris information can be made incomplete by making one or more of these parameters incomplete. For example, the ephemeris information could include “X, Y, Z” position coordinates of the satellite as parameters and the ephemeris information could be made incomplete by only including the most significant bits (MSBs) of the position coordinates of the “X” axis while providing complete ephemeris information for the “Y” and “Z” position coordinates.

In another example, the epoch time indicated by the broadcast incomplete ephemeris information is incomplete. For example, the epoch time may be incomplete such that the UE can determine the orbital trajectory of the satellite but cannot determine where the satellite is on that trajectory. The complete ephemeris information transmitted by dedicated signalling then provides the complete epoch time (or, at least, the missing portion of the epoch time broadcast within the incomplete ephemeris information).

In another example, an error term is added to the ephemeris information to make it incomplete before it is broadcast as incomplete ephemeris information. Addition of the error term changes a portion of the ephemeris information to make it erroneous, meaning only the remaining portion of the ephemeris information is correct. The broadcast ephemeris information is therefore incomplete, since only a portion of the broadcast ephemeris information is actually correct. In an example, a random (or pseudo-random) error term known only to the network is added to the ephemeris information to be broadcast. The broadcast incomplete ephemeris information is then subsequently overwritten by the complete ephemeris information transmitted by dedicated signalling (which does not include the error term).

In another example, a portion of the broadcast ephemeris information is ciphered. For example, a portion of the bits representing the broadcast ephemeris information are ciphered or scrambled. While the UE is accessing the system (e.g. performing an initial access procedure), the UE does not know the deciphering key or scrambling sequence. It therefore cannot access the complete ephemeris information (rather, it can access only the non-ciphered or non-scrambled portion). Once the UE has verified its location during the initial access procedure, however, dedicated signalling (e.g. in Msg4) provides the deciphering key (to decipher the ciphered portion) or scrambling sequence (to descramble the scrambled portion), thereby allowing the UE to decode the complete ephemeris information.

It may be desirable for a UE in RRC connected mode to continually read broadcast ephemeris information (e.g. broadcast as system information) in order to maintain time and frequency synchronization with the network. If the broadcast ephemeris information is incomplete, an alternative is to provide the UE with updated ephemeris information via dedicated signalling. However, this may increase signalling overhead. The current example helps address this scenario by allowing a deciphering key or scrambling sequence to be provided by dedicated signalling after UE location verification. The UE can then obtain the complete ephemeris information from subsequently broadcast incomplete ephemeris information by completing the necessary decipher or descramble operation. This reduces signalling overhead, since the deciphering key or scrambling sequence needs to be transmitted only once by dedicated signalling and the UE is then able to obtain the latest complete ephemeris information via the broadcast ephemeris information. At the same time, a UE whose location has not been verified is unable to obtain the complete ephemeris information from the broadcast ephemeris information, since that UE does not have the deciphering key or scrambling sequence needed to decipher or descramble the relevant portion of the broadcast ephemeris information. The integrity of the system is therefore maintained while signalling overhead is reduced.

In an example, separate physical communication resources (e.g. time and/or frequency resources) are used when a UE uses broadcast incomplete ephemeris information. The use of incomplete ephemeris information will lead to the signals and channels used for communication between the UE and the network being incorrectly formed. For example, the UE-specific timing advance applied by the UE may be inaccurate or the frequency compensation applied may be incorrect. Thus, while the UE is operating based on incomplete ephemeris information, separate physical communication resources are used. For example, the separate physical communication resources are separated in time and/or frequency from physical communication resources used by UEs with access to complete ephemeris information such that errors in UE-specific timing advance and/or frequency compensation do not cause interference on signals transmitted between the UEs with access to complete ephemeris information and the network.

For instance, separate PUSCH resources in the time domain may be used. This alleviates the problem of PUSCH resources that have been inaccurately timing advanced or frequency compensated due to incomplete ephemeris information causing interference to accurately timing advanced and frequency compensated PUSCH resources. This principle may also be applied to other channels (such as PRACH).

In another example, a higher subcarrier spacing is applied to PUSCH resources used for transmission by UEs with only incomplete ephemeris information (compared to transmission by UEs with complete ephemeris information). This increases tolerance to frequency offsets and ICI (inter subcarrier interference). This principle may also be applied to other channels (such as PRACH).

In an example, in the scenario exemplified in FIG. 11, the network may jitter the transmission times of the DL positioning reference signals.

When the DL positioning reference signals are jittered, if a UE has complete ephemeris information, it may still apply a known timing offset to the verification information it provides to the network in order to indicate to the network it is in a different location to its actual location (e.g. by applying a timing offset associated with location Y when it is actually at location X in FIG. 13). On the other hand, when the DL positioning reference signals are jittered and the ephemeris information is incomplete, the UE does not know when the DL positioning reference signals were transmitted or the amount by which the reported verification information should be adjusted in order to allow its false location to be verified. The network, however, knows both the satellite location and the jitter applied to each set of DL positioning reference signals. The network can therefore interpret the verification information provided by the UE using the known satellite location and jitter in order to verify the UE's genuine location. However, since the UE knows neither the precise satellite location (since it does not have the complete ephemeris information) nor the jitter (since this is not provided to the UE), verification information for a false location of the UE cannot be easily generated by the UE. Jittering the DL positioning reference signals thus helps further protect against false UE location reporting since, even if the UE were to guess the complete ephemeris information (and therefore determine the precise location of the satellite), it would still not know exactly when each DL positioning reference signal was transmitted due to the applied jitter.

In the above examples, the UE location verification procedure occurs during the initial access procedure. By performing the location verification at this early stage, an RRC connection is only set up in the first place if the UE's location is verified. However, location verification may happen at other times.

In an example, the UE is provided with an RRC connection at initial access without UE location verification. This RRC connection may be referred to as a probationary RRC connection. In order for the RRC connection to be continued, the UE's location must be verified within a certain time period. For example, for the scenario exemplified in FIG. 11 or 12, the UE may be given a probationary RRC connection for 40 seconds. The duration of the probationary RRC connection is determined to be sufficient to allow the satellite to traverse the sky to a sufficient degree that the verification information can be generated. At the end of the probationary period, if the UE's location has been successfully verified, the UE is signalled the complete ephemeris information and the RRC connection continues. If the UE's location is not verified, the RRC connection may be dropped by the network.

In an example, during the probationary RRC connection, a data amount cap or data rate cap is applied. This cap limits UE functionality until the UE location is verified.

In an example, the UE is scheduled in separate physical communication resources (e.g. time and/or frequency resources) during the probationary RRC connection. As explained above, these separate physical communication resources are designated for use by UEs which have not yet received the complete ephemeris information. For example, the UE may be scheduled in separate PUSCH resources, as previously discussed. As previously discussed, this helps alleviate performance degradation (e.g. interference) associated with UEs operating based on incomplete ephemeris information. The available separate physical communication resources may be limited, thereby limiting the data rate available to UEs that have an unverified location.

In an example, the UE connection is constrained during the probationary RRC connection. The UE connection may be constrained in various ways until the UE location is verified.

For instance, the UE may have no internet connection during the probationary RRC connection. For example, the UE may only be allowed to access the operator's intranet or use other non-internet connections.

As another example, a different internet connection charging scheme may be applied for the UE during the probationary RRC connection. For example, an operator may apply a discounted tariff for operation within one country (e.g. the “home” country) and a standard tariff for operation internationally. The standard tariff is applied for the UE until the UE location is verified. If the UE location is verified as being in the “home” country, the discounted tariff is then applied.

As another example, different internet content may be available to the UE during the probationary RRC connection. For instance, the UE location may need to be verified to determine whether the UE is allowed to access internet content that is acceptable in jurisdiction A or that is acceptable in jurisdiction B (e.g. depending on copyright permissions of the content). A so-called safe internet connection may therefore be established during the probationary RRC connection which allows the UE to access only the subset of internet content that is acceptable in both jurisdiction A and jurisdiction B. Once the UE's location has been verified, the UE is able to access the full set of internet content that is allowed in the jurisdiction in which the UE is located.

In an example, a UE that previously failed location verification is not assigned a probationary RRC connection. In this case, the UE is considered a suspect UE and is not assigned a probationary RRC connection. Rather, the UE location verification information which verifies the UE's reported location must be ascertained prior to the UE accessing the network. This may entail a delay (for example, a delay of up to 40 seconds for the scenario exemplified in FIG. 11 or 12). The network may maintain a database of UEs which have recently (e.g. over a rolling past predetermined time period, e.g. the last 90 seconds) failed location verification. If a UE identified in the database attempts to access the network without location verification information being provided (e.g. by requesting a probationary RRC connection), the connection attempt is refused. A UE that has recently failed location verification is thus only able to access the network if verification information is available at the initial access stage.

In an example, a UE is given a temporary RRC connection in order to receive information to allow location verification. If the UE does not provide location verification information during the initial access stage, it is provided with the temporary RRC connection. During the temporary RRC connection, the UE is signalled the information required for location verification. For instance, in the scenario exemplified in FIG. 11, the UE is signalled the configuration of the DL positioning reference signals or, in the scenario exemplified in FIG. 12, the UE is signalled the configuration of the UL positioning reference signals and resource assignment for those signals. In an example, the DL or UL positioning signal configuration may be transmitted in Msg4 (RRC Setup) of the initial access procedure for the temporary RRC connection. The temporary RRC connection may then be dropped while the UE generates the location verification information. If the UE has been configured to transmit UL signals (as exemplified in FIG. 12), the UE can transmit the configured UL signals after the temporary RRC connection has been dropped. The initial access procedure to generate a further RRC connection then uses this location verification information (e.g. as exemplified in FIGS. 14 and 15).

The examples above relate, for example, to the transition between RRC idle mode and RRC connected mode. In RRC Connected mode, the UE may need to continually re-read the ephemeris information as it is updated. There may also be multiple handovers between satellites during the time of the connection. These events provide opportunities to re-verify the UE location.

In one example, generation of verification information is required after the UE re-reads the broadcast ephemeris information. Since the broadcast ephemeris information is incomplete, the network may verify the UE location when the UE re-reads the broadcast ephemeris information and provide the complete ephemeris information only when the UE's location is verified. If the network does not require re-verification of the UE location when the UE re-reads the broadcast ephemeris information (or at least does not require re-verification every time the UE re-reads the broadcast ephemeris information), it can signal the information required to derive the complete ephemeris information (for example, the deciphering key or scrambling sequence if a portion of the broadcast ephemeris information is ciphered or scrambled or the missing least significant bits of the broadcast ephemeris information) to the UE using dedicated signalling.

In another example, the UE may request the information to derive the complete ephemeris information (e.g. deciphering key, scrambling sequence or missing least significant bits) prior to re-reading the broadcast ephemeris information. The network can then respond, for example, with the requested information (e.g. if the network does not require the UE location to be re-verified), no information (e.g. if the network does require the UE location to be re-verified) or knowingly false or imprecise information (e.g. if the network does require the UE location to be re-verified).

UE location verification may be required after the UE reads broadcast incomplete ephemeris information from a new satellite in RRC Connected mode. When there is a handover between satellites, the UE is required to read the ephemeris information that is broadcast via that new satellite. In an example, the UE location needs to be verified when such a handover occurs. Since the UE does not know the complete ephemeris information of the new satellite, it is unable to spoof the correct location verification information. If the network does not require UE location verification following handover, it may, for example, signal the complete ephemeris information (or the information to derive the complete ephemeris information (e.g. deciphering key, scrambling sequence or missing least significant bits)) to the UE via dedicated signalling before handover.

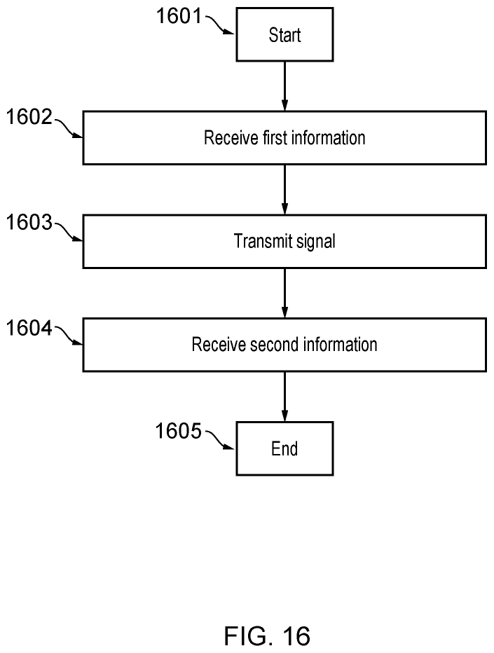

FIG. 16 shows a method carried out by a wireless telecommunications apparatus (e.g. UE 1010, 1310) according to an embodiment.

The method starts at step 1601.

At step 1602, the wireless telecommunications apparatus is controlled (e.g. by controller 44) to receive (e.g. via receiver 48) first information associated with a satellite (e.g. satellite 1001, 1301) of the non-terrestrial wireless telecommunications network, the first information comprising incomplete ephemeris information of the satellite. The first information is received from the network, for example via a satellite (e.g. satellite 1001, 1301) or from a terrestrial node of the network acting as a TRP.

At step 1603, the wireless telecommunications apparatus is controlled (e.g. by controller 44) to transmit (e.g. via transmitter 49) a signal usable by a second wireless telecommunications apparatus to verify a location of the wireless telecommunications apparatus relative to the satellite. For example, the transmitted signal may indicate an interarrival time of DL positioning reference signals (as exemplified in FIG. 11) or be one of a plurality of transmitted UL positioning reference signals (as exemplified in FIG. 12). The transmitted signal is transmitted to the network, for example to a satellite (e.g. satellite 1001, 1301) or to a terrestrial node of the network acting as a TRP.

At step 1604, the wireless telecommunications apparatus is controlled (e.g. by controller 44) to receive (e.g. via receiver 48) second information associated with the satellite, the second information being usable by the wireless telecommunications apparatus to determine complete ephemeris information of the satellite. The second information is received from the network, for example from a satellite (e.g. satellite 1001, 1301) or from a terrestrial node of the network acting as a TRP.

The method ends at step 1605.

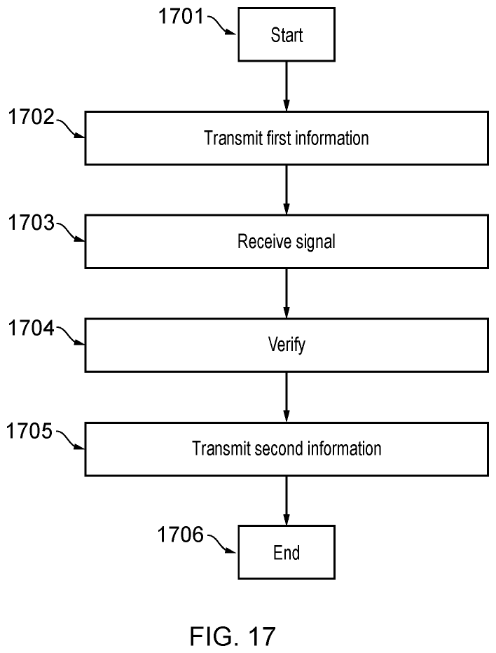

FIG. 17 shows a method carried out by a wireless telecommunications apparatus (e.g. a satellite, such as satellite 1001, 1301, or a terrestrial node of the network acting as TRP) according to an embodiment.

The method starts at step 1701.

At step 1702, the wireless telecommunications apparatus is controlled (e.g. by controller 34) to transmit (e.g. via transmitter 30), to a second wireless telecommunications apparatus (e.g. UE 1010, 1310), first information associated with a satellite (e.g. satellite 1001, 1301) of the non-terrestrial wireless telecommunications network, the first information comprising incomplete ephemeris information of the satellite.

At step 1703, the wireless telecommunications apparatus is controlled (e.g. by controller 34) to receive (e.g. via receiver 32) a signal usable by the wireless telecommunications apparatus to verify a location of the second wireless telecommunications apparatus relative to the satellite. For example, the received signal may indicate an interarrival time of DL positioning reference signals (as exemplified in FIG. 11) or be one of a plurality of transmitted UL positioning reference signals (as exemplified in FIG. 12).

At step 1704, the wireless telecommunications apparatus is controlled (e.g. by controller 34) to verify the location of the second wireless telecommunications apparatus relative to the satellite using the received signal.

At step 1705, if the location of the second wireless telecommunications apparatus relative to the satellite is verified, the wireless telecommunications apparatus is controlled (e.g. by controller 34) to transmit (e.g. via transmitter 30), to the second wireless telecommunications apparatus, second information associated with the satellite, the second information being usable by the wireless telecommunications apparatus to determine complete ephemeris information of the satellite.

The method ends at step 1706.

Embodiment(s) of the present technique are defined by the following numbered clauses:
1. A wireless telecommunications apparatus for use with a non-terrestrial wireless telecommunications network, the wireless telecommunications apparatus comprising circuitry configured to:
   receive first information associated with a satellite of the non-terrestrial wireless telecommunications network, the first information comprising incomplete ephemeris information of the satellite;
   transmit a signal usable by a second wireless telecommunications apparatus to verify a location of the wireless telecommunications apparatus; and
   receive second information associated with the satellite, the second information being usable by the wireless telecommunications apparatus to determine complete ephemeris information of the satellite.
2. A wireless telecommunications apparatus according to clause 1, wherein:
   the incomplete ephemeris information comprises a number of only the most significant bits of the complete ephemeris information; and the second information comprises at least the one or more remaining bits of the complete ephemeris information.
3. A wireless telecommunications apparatus according to clause 1, wherein:
   the incomplete ephemeris information comprises only a portion of an epoch time of the ephemeris information of the satellite; and
   the second information comprises at least the remaining portion of the epoch time of the ephemeris information of the satellite.
4. A wireless telecommunications apparatus according to clause 1, wherein:
   the incomplete ephemeris information comprises the complete ephemeris information with an error applied to only a portion of the complete ephemeris information; and
   the second information comprises at least the portion of the complete ephemeris information without the error applied.
5. A wireless telecommunications apparatus according to clause 1, wherein:
   the incomplete ephemeris information comprises the complete ephemeris information with only a portion of the complete ephemeris information ciphered or scrambled; and
   the second information comprises a deciphering key or scrambling sequence for deciphering or descrambling the ciphered or scrambled portion of the complete ephemeris information.
6. A wireless telecommunications apparatus according to any preceding clause, wherein, before receiving the second information, the circuitry is configured to transmit or receive signals using physical communication resources which are separate to physical communication resources used by other wireless telecommunications apparatuses with access to the complete ephemeris information of the satellite.
7. A wireless telecommunications apparatus according to any preceding clause, wherein, before receiving the second information, the circuitry is configured to transmit or receive signals using a higher subcarrier spacing than the subcarrier spacing used by other wireless telecommunications apparatuses with access to the complete ephemeris information of the satellite.
8. A wireless telecommunications apparatus according to any preceding clause, wherein the signal usable by the second wireless telecommunications apparatus to verify the location of the wireless telecommunications apparatus with respect to the satellite comprises information indicating an interarrival time of downlink positioning reference signals received from the satellite.
9. A wireless telecommunications apparatus according to clause 8, wherein the downlink positioning reference signals received from the satellite are jittered.
10. A wireless telecommunications apparatus according to any of clauses 1 to 7, wherein the signal usable by the second wireless telecommunications apparatus to verify the location of the wireless telecommunications apparatus with respect to the satellite comprises an uplink reference signal transmitted at a known time relative to a downlink subframe timing.
11. A wireless telecommunications apparatus according to any preceding clause, wherein the circuitry is configured to receive the first information when updated ephemeris information of the satellite is available.
12. A wireless telecommunications apparatus according to any preceding clause, wherein the circuitry is configured to receive the first information in response to handover of the wireless telecommunications apparatus to the satellite.
13. A wireless telecommunications apparatus for use with a non-terrestrial wireless telecommunications network, the wireless telecommunications apparatus comprising circuitry configured to:
   transmit, to a second wireless telecommunications apparatus, first information associated with a satellite of the non-terrestrial wireless telecommunications network, the first information comprising incomplete ephemeris information of the satellite;
   receive a signal usable by the wireless telecommunications apparatus to verify a location of the second wireless telecommunications apparatus;
   verify the location of the second wireless telecommunications apparatus using the received signal; and
   if the location of the second wireless telecommunications apparatus is verified, transmit, to the second wireless telecommunications apparatus, second information associated with the satellite, the second information being usable by the wireless telecommunications apparatus to determine complete ephemeris information of the satellite.
14. A wireless telecommunications apparatus according to clause 13, wherein:
   the incomplete ephemeris information comprises a number of only the most significant bits of the complete ephemeris information; and
   the second information comprises at least the one or more remaining bits of the complete ephemeris information.
15. A wireless telecommunications apparatus according to clause 13, wherein:
   the incomplete ephemeris information comprises only a portion of an epoch time of the ephemeris information of the satellite; and
   the second information comprises at least the remaining portion of the epoch time of the ephemeris information of the satellite.
16. A wireless telecommunications apparatus according to clause 13, wherein:
   the incomplete ephemeris information comprises the complete ephemeris information with an error applied to only a portion of the complete ephemeris information; and
   the second information comprises at least the portion of the complete ephemeris information without the error applied.
17. A wireless telecommunications apparatus according to clause 13, wherein:
   the incomplete ephemeris information comprises the complete ephemeris information with only a portion of the complete ephemeris information ciphered or scrambled; and
   the second information comprises a deciphering key or scrambling sequence for deciphering or descrambling the ciphered or scrambled portion of the complete ephemeris information.
18. A wireless telecommunications apparatus according to any of clauses 13 to 17, wherein, before transmitting the second information, the circuitry is configured to transmit signals to or receive signals from the second wireless telecommunications apparatus using physical communication resources which are separate to physical communication resources used by other wireless telecommunications apparatuses with access to the complete ephemeris information of the satellite.
19. A wireless telecommunications apparatus according to any of clauses 13 to 18, wherein, before transmitting the second information, the circuitry is configured to transmit signals to or receive signals from the second wireless telecommunications apparatus using a higher subcarrier spacing than the subcarrier spacing used by other wireless telecommunications apparatuses with access to the complete ephemeris information of the satellite.
20. A wireless telecommunications apparatus according to any of clauses 13 to 19, wherein the signal usable by the wireless telecommunications apparatus to verify the location of the second wireless telecommunications apparatus with respect to the satellite comprises information indicating an interarrival time of downlink positioning reference signals received from the satellite.
21. A wireless telecommunications apparatus according to clause 20, wherein the downlink positioning reference signals received from the satellite are jittered.
22. A wireless telecommunications apparatus according to any of clauses 13 to 19, wherein the signal usable by the wireless telecommunications apparatus to verify the location of the second wireless telecommunications apparatus with respect to the satellite comprises an uplink reference signal transmitted at a known time relative to a downlink subframe timing.
23. A wireless telecommunications apparatus according to any of clauses 13 to 22, wherein the circuitry is configured to transmit the first information when updated ephemeris information of the satellite is available.
24. A wireless telecommunications apparatus according to any of clauses 13 to 23, wherein the circuitry is configured to transmit the first information in response to handover of the wireless telecommunications apparatus to the satellite.
25. A method of operating a wireless telecommunications apparatus for use with a non-terrestrial wireless telecommunications network, the method comprising controlling the wireless telecommunications apparatus to:
   receive first information associated with a satellite of the non-terrestrial wireless telecommunications network, the first information comprising incomplete ephemeris information of the satellite;
   transmit a signal usable by a second wireless telecommunications apparatus to verify a location of the wireless telecommunications apparatus; and
   receive second information associated with the satellite, the second information being usable by the wireless telecommunications apparatus to determine complete ephemeris information of the satellite.
26. A method of operating a wireless telecommunications apparatus for use with a non-terrestrial wireless telecommunications network, the method comprising controlling the wireless telecommunications apparatus to:
   transmit, to a second wireless telecommunications apparatus, first information associated with a satellite of the non-terrestrial wireless telecommunications network, the first information comprising incomplete ephemeris information of the satellite;
   receive a signal usable by the wireless telecommunications apparatus to verify a location of the second wireless telecommunications apparatus;
   verify the location of the second wireless telecommunications apparatus using the received signal; and
   if the location of the second wireless telecommunications apparatus is verified, transmit, to the second wireless telecommunications apparatus, second information associated with the satellite, the second information being usable by the wireless telecommunications apparatus to determine complete ephemeris information of the satellite.
27. A program for controlling a computer to perform a method according to clause 25 or 26.
28. A storage medium storing a program according to clause 27.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

### REFERENCES

[1] 3GPP RP-220953. “NR NTN (Non-Terrestrial Networks) enhancements”. RAN plenary # 95e. March 2022.
[2] 3GPP RP-221013. <<95e-25 email discussion
[3] 3GPP RP-220139: Network verified UE location aspects; THALES
[4] 3GPP RP-220174: Network verification of UE location in NTN; Qualcomm Incorporated 79
[5] 3GPP RP-220200: On Network-verified UE location for NR NTN; Intel Corporation
[6] 3GPP RP-220421: Discussion on network-verified UE location for NR NTN; Huawei, HiSilicon
[7] R2-2101150 Summary of [Post112-e] [115] [NTN] the Email Discussion on LCS for NTN, Fraunhofer IIS, Fraunhofer HHI
[8] R2-2102679. “Reply LS on UE location aspects in NTN”. RAN2 #113bis_e. April 2021.
[9] 3GPP TS 38.305 V16.0.0 (2020-03): 3rd Generation Partnership Project; Technical Specification Group Radio Access Network; NG Radio Access Network (NG-RAN); Stage 2 functional specification of User Equipment (UE) positioning in NG-RAN (Release 16)
[10] 3GPP TS38.331 [ref: R2-2204112]

1. A wireless telecommunications apparatus for use with a non-terrestrial wireless telecommunications network, the wireless telecommunications apparatus comprising circuitry configured to:
receive first information associated with a satellite of the non-terrestrial wireless telecommunications network, the first information comprising incomplete ephemeris information of the satellite;
transmit a signal usable by a second wireless telecommunications apparatus to verify a location of the wireless telecommunications apparatus; and
receive second information associated with the satellite, the second information being usable by the wireless telecommunications apparatus to determine complete ephemeris information of the satellite.

2. A wireless telecommunications apparatus according to claim 1, wherein:
the incomplete ephemeris information comprises a number of only the most significant bits of the complete ephemeris information; and
the second information comprises at least the one or more remaining bits of the complete ephemeris information.

3. A wireless telecommunications apparatus according to claim 1, wherein:
the incomplete ephemeris information comprises only a portion of an epoch time of the ephemeris information of the satellite; and
the second information comprises at least the remaining portion of the epoch time of the ephemeris information of the satellite.

4. A wireless telecommunications apparatus according to claim 1, wherein:
the incomplete ephemeris information comprises the complete ephemeris information with an error applied to only a portion of the complete ephemeris information; and
the second information comprises at least the portion of the complete ephemeris information without the error applied.

5. A wireless telecommunications apparatus according to claim 1, wherein:
the incomplete ephemeris information comprises the complete ephemeris information with only a portion of the complete ephemeris information ciphered or scrambled; and
the second information comprises a deciphering key or scrambling sequence for deciphering or descrambling the ciphered or scrambled portion of the complete ephemeris information.

6. A wireless telecommunications apparatus according to claim 1, wherein, before receiving the second information, the circuitry is configured to transmit or receive signals using physical communication resources which are separate to physical communication resources used by other wireless telecommunications apparatuses with access to the complete ephemeris information of the satellite.

7. A wireless telecommunications apparatus according to claim 1, wherein, before receiving the second information, the circuitry is configured to transmit or receive signals using a higher subcarrier spacing than the subcarrier spacing used by other wireless telecommunications apparatuses with access to the complete ephemeris information of the satellite.

8. A wireless telecommunications apparatus according to claim 1, wherein the signal usable by the second wireless telecommunications apparatus to verify the location of the wireless telecommunications apparatus with respect to the satellite comprises information indicating an interarrival time of downlink positioning reference signals received from the satellite.

9. A wireless telecommunications apparatus according to claim 8, wherein the downlink positioning reference signals received from the satellite are jittered.

10. A wireless telecommunications apparatus according to claim 1, wherein the signal usable by the second wireless telecommunications apparatus to verify the location of the wireless telecommunications apparatus with respect to the satellite comprises an uplink reference signal transmitted at a known time relative to a downlink subframe timing.

11. A wireless telecommunications apparatus according to claim 1, wherein the circuitry is configured to receive the first information when updated ephemeris information of the satellite is available.

12. A wireless telecommunications apparatus according to claim 1, wherein the circuitry is configured to receive the first information in response to handover of the wireless telecommunications apparatus to the satellite.

13.-24. (canceled)

25. A method of operating a wireless telecommunications apparatus for use with a non-terrestrial wireless telecommunications network, the method comprising controlling the wireless telecommunications apparatus to:
receive first information associated with a satellite of the non-terrestrial wireless telecommunications network, the first information comprising incomplete ephemeris information of the satellite;
transmit a signal usable by a second wireless telecommunications apparatus to verify a location of the wireless telecommunications apparatus; and
receive second information associated with the satellite, the second information being usable by the wireless telecommunications apparatus to determine complete ephemeris information of the satellite.

26. A method of operating a wireless telecommunications apparatus for use with a non-terrestrial wireless telecommunications network, the method comprising controlling the wireless telecommunications apparatus to:
transmit, to a second wireless telecommunications apparatus, first information associated with a satellite of the non-terrestrial wireless telecommunications network, the first information comprising incomplete ephemeris information of the satellite;
receive a signal usable by the wireless telecommunications apparatus to verify a location of the second wireless telecommunications apparatus;
verify the location of the second wireless telecommunications apparatus using the received signal; and
if the location of the second wireless telecommunications apparatus is verified, transmit, to the second wireless telecommunications apparatus, second information associated with the satellite, the second information being usable by the wireless telecommunications apparatus to determine complete ephemeris information of the satellite.

27.-28. (canceled)
